(19) United States
(12) Patent Application Publication
(10) Pub. No.: US 2013/0080345 A1
(43) Pub. Date: Mar. 28, 2013

(54) SYSTEMS AND METHODS FOR SHARING VEHICLE INFORMATION IN A DISTRIBUTED NETWORK

(71) Applicant: Maxime Marcel Rassi, Boston, MA (US)

(72) Inventor: Maxime Marcel Rassi, Boston, MA (US)

(21) Appl. No.: 13/625,150

(22) Filed: Sep. 24, 2012

Related U.S. Application Data
(60) Provisional application No. 61/538,367, filed on Sep. 23, 2011.

(51) Int. Cl. G06Q 99/00

(52) U.S. Cl. 705/319

(57) ABSTRACT

A system and method for sharing vehicle information in a social networking system is disclosed. In one example, the method includes receiving identification information and vehicle information relating to a plurality of vehicles, including the vehicle information relating to the first vehicle and an identification of a first vehicle associated with a first user, storing the identification information and the vehicle information relating to the plurality of vehicles in the social networking system, comparing the identification information and the vehicle information relating to the first vehicle to the identification information and the vehicle information relating to the plurality of vehicles to determine at least one relation between the first vehicle and the plurality of vehicles, and transmitting to a plurality of users statistical information based on the at least one relation, associated with the first vehicle and the plurality of vehicles defined in the social networking system.

### RELATED APPLICATIONS

This application claims priority under 35 U.S.C. §119(e) to U.S. Provisional Application Ser. No. 61/538,367, entitled “SYSTEMS AND METHODS FOR SHARING VEHICLE INFORMATION IN A DISTRIBUTED NETWORK,” filed on Sep. 23, 2011, which is hereby incorporated herein by reference in its entirety.

### BACKGROUND

There are many services in use today that allow users to communicate with others about automobile-related topics. For example, Edmunds.com (http://www.edmunds.com) is a website dedicated to providing users with automobile information, such as prices for new and used vehicles, national and regional incentives and rebates, test drive reviews by Edmunds.com editors, and tips and advice on other aspects of vehicle purchases and ownership. Other websites (e.g., http://www.automotiveforums.com) allow users to post automobile-related questions or comments, and to search for messages posted by others by car make and model.

There also exist many social networking services that allow users to set up a user profile based on the user's identity and communicate with friends or acquaintances. For example, Facebook (e.g. http://www.facebook.com) allows users to enter specific identifying personal information and select friends with whom to share online postings. Many other services exist that permit users to share personal information within a social network.

### SUMMARY

Although automobile information services and social networking services exist, it is appreciated that it would be beneficial to provide users with a social network centered around a user's vehicle rather than centered around the users themselves. For instance, it is appreciated that a social network based on a user's vehicle would more accurately connect owners of different types of vehicles that share specific vehicle-related characteristics.

Furthermore, it would be beneficial for a particular user to access several different types of information relating to vehicles from a single source. For example, a user may want to compare insurance prices for similar cars in a particular location or region, a user may want to look at the demographics of the owners of similar vehicles, and a user may want to pose questions to those owning a similar vehicle. Accordingly, systems and methods described herein provide a service that provides a vehicle-centered experience for users to post or read vehicle-related comments or questions, and to search for particular vehicle-related information.

In one example, the systems and methods are provided for a service that is centered around the vehicles, rather than specific users. According to one aspect, each user remains anonymous. In this example, the only information about each user that may be accessible to other users is vehicle information, which may already be publically available (e.g. one can determine this information by seeing the vehicle on a public street).

In one example, a user's identification information may include the user's license plate number and state. According to one embodiment, the service may aggregate and provide vehicle insurance statistics based on user-input data. For example, each user may provide information about the user's vehicle, such as make, model, and year, as well as personal information such as city and state of residence, age, and license points. Another user may enter similar information and request a comparative vehicle insurance estimate, and the service may select similar user vehicle profiles and, based on other users' input vehicle information, calculate average, median, high and low vehicle insurance premium information.

According to one embodiment, a computer-implemented method for sharing vehicle information in a social networking system is disclosed. In one example, the method comprises the acts of receiving identification information relating to a plurality of vehicles, including an identification of a first vehicle associated with a first user, receiving vehicle information relating to the plurality of vehicles, including the vehicle information relating to the first vehicle, storing the identification information and the vehicle information relating to the plurality of vehicles to define the social networking system, comparing, by a processor, the identification information and the vehicle information relating to the first vehicle to the identification information and the vehicle information relating to the plurality of vehicles to determine at least one relation between the first vehicle and the plurality of vehicles, based on the vehicle information, and transmitting to a plurality of users statistical information based on the at least one relation, associated to the first vehicle and the plurality of vehicles defined in the social networking system.

In another example, the method further comprises receiving from the plurality of users a plurality of sets of vehicle information, each set of vehicle information relating to each of the plurality of vehicles, determining a subset of the plurality of vehicles that match at least one characteristic of each set of vehicle information, calculating user vehicle statistics based on the sets of vehicle information of the subset of vehicles, and transmitting the user vehicle statistics to the first user. In addition, calculating may be further based on sets of driver information for a subset of the plurality of users corresponding to the subset of the plurality of vehicles. Further, the method may also comprise identifying each user of the plurality of users based on at least one characteristic of each user's set of vehicle information to determine a subset of users to define each user's social networking system, and receiving a message from the first user to communicate with any user of the subset of users.

In one example, selecting a subset of the plurality of vehicles is further based on the first set of vehicle information. In another example, selecting a subset of the plurality of vehicles is further based on the first user's search query. In addition, the user vehicle statistics may include insurance premium statistics.

In another example, the identification information includes any of the first vehicle license plate number and the first vehicle state of registration. In addition, the vehicle information may include any of the first vehicle make, model, year, mileage, exterior color, interior color and interior fabric.

In one example, the method further comprises receiving a plurality of reviews from a subset for the plurality of users, transmitting the plurality of the reviews to the plurality of users, aggregating the plurality of reviews to determine a review overview, and transmitting the review overview to the plurality of users. In addition, the method may further comprise receiving advertisements for rent from a set of the plurality of users of the corresponding plurality vehicles, and transmitting to the plurality of users the advertisement for rent of the corresponding plurality vehicles. In another example, the method further comprises receiving advertisements for sale from a set of the plurality of users of the corresponding plurality vehicles, and transmitting to the plurality of users the advertisement for sale of the corresponding plurality vehicles.

According to another embodiment, a system for providing a vehicle information and social networking service is disclosed. In one example, the system comprises an interface configured to receive vehicle identification and vehicle information relating to a plurality of vehicles, including identification and vehicle information of a first vehicle associated with a first user, a storage medium configured to store the vehicle identification, and the vehicle information relating to the plurality of vehicles to define the social networking system, and a processor configured to compare the identification information and the vehicle information relating to the first vehicle to the identification information and the vehicle information relating to the plurality of vehicles to determine at least one relation between the first vehicle and the plurality of vehicles, based on the vehicle information, wherein the interface is configured to transmit to a plurality of users statistical information based on the at least one relation, associated to the first vehicle and the plurality of vehicles defined in the social networking system.

In one example, the processor selects a subset of the plurality of users based on a first user's vehicle information. In addition, the processor may select the subset of the plurality of users based on the first user's search query.

According to another embodiment, a computer-implemented method for providing vehicle insurance premium estimates is disclosed. In one example, the method comprises receiving, from a first user, user information, and vehicle information, determining, based on the vehicle information, the user information of the first user, a plurality of user profiles having similar vehicle information, and user information, each the plurality of user profiles having an insurance premium, calculating a vehicle insurance premium estimate based on the insurance premiums in the plurality of user profiles, and transmitting the vehicle insurance premium estimate to the first user.

In another example, the vehicle information of the first user includes at least one of make, model, year, exterior color, interior color and interior fabric. In addition, the method may further comprise receiving driver history, and vehicle registration location of the first user. In another example, the method comprises receiving from a plurality of users the insurance premium.

According to another embodiment, a non-transitory computer readable medium having computer readable instructions stored thereon, which, when executed by a computer, instruct the computer to perform a method comprising receiving identification information relating to a plurality of vehicles, including an identification of a first vehicle associated with a first user, receiving vehicle information relating to the plurality of vehicles, including the vehicle information relating to the first vehicle, storing the identification information and the vehicle information relating to the plurality of vehicles to define the social networking system, comparing the identification information and the vehicle information relating to the first vehicle to the identification information and the vehicle information relating to the plurality of vehicles to determine at least one relation between the first vehicle and the plurality of vehicles, based on the vehicle information, and transmitting to a plurality of users statistical information based on the at least one relation, associated to the first vehicle and the plurality of vehicles defined in the social networking system.

Still other aspects, examples, and advantages of these exemplary aspects and examples, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any example disclosed herein may be combined with any other example. References to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE FIGURES

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 shows a block diagram of an overview of a distributed network, including a service according to an embodiment of the invention;

FIG. 2A shows an interface including a user information input interface according to an embodiment of the invention;

FIG. 2B shows another interface including a user information input interface according to another embodiment of the invention;

FIG. 3A shows an example of a user profile screen including a driver area screen according to an embodiment of the invention;

FIG. 3B shows an example of a user profile screen including a vehicle area screen according to an embodiment of the invention;

FIG. 4A shows an interface including parameters which may be set by a user for refining retrieved information according to an embodiment of the invention;

FIG. 4B shows another interface including parameters which may be set by a user for refining retrieved information according to an embodiment of the invention;

FIG. 5 shows an example of parameters which may be displayed by the system in response to a user request according to an embodiment of the invention;

FIG. 6 shows a flow chart of a method for producing a vehicle information and social networking website according to an embodiment of the invention;

FIG. 7 shows a flow chart of a method for providing a vehicle insurance estimate according to an embodiment of the invention;

FIG. 8 shows an example computer system with which various aspects of the invention may be practiced; and

FIG. 9 shows an example storage system capable of implementing various aspects of the present invention.

### DETAILED DESCRIPTION

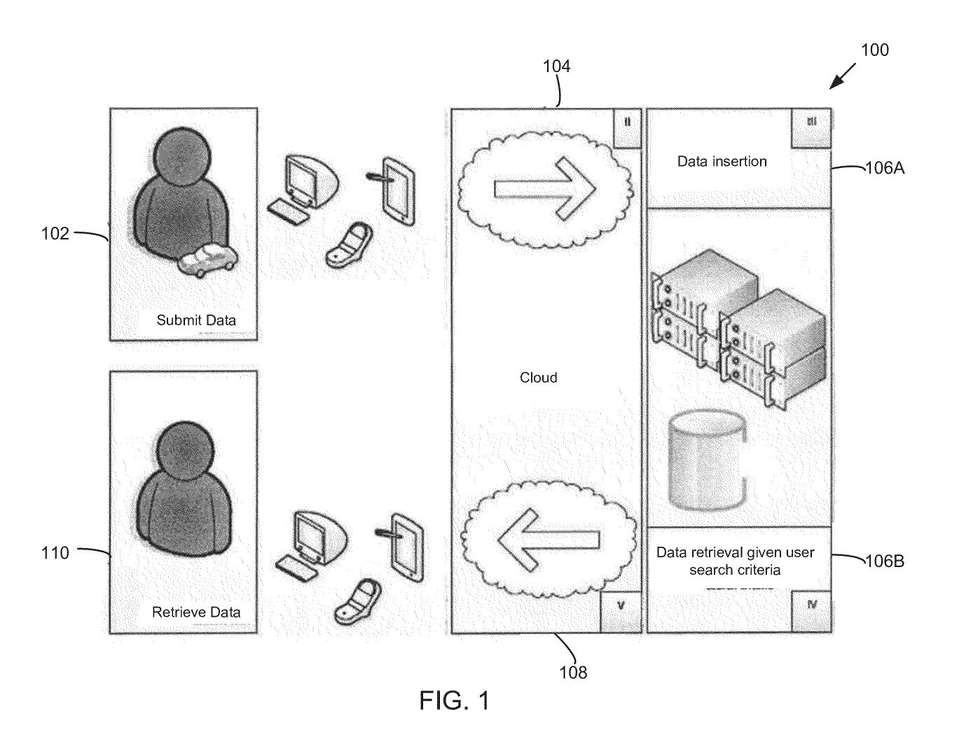

As discussed above, there exists a need for a vehicle-centered social networking and information service that provides a vehicle-centered experience for a user. FIG. 1 shows a block diagram of an overview of a service 100 as part of a distributed network that incorporates various aspects of the invention.

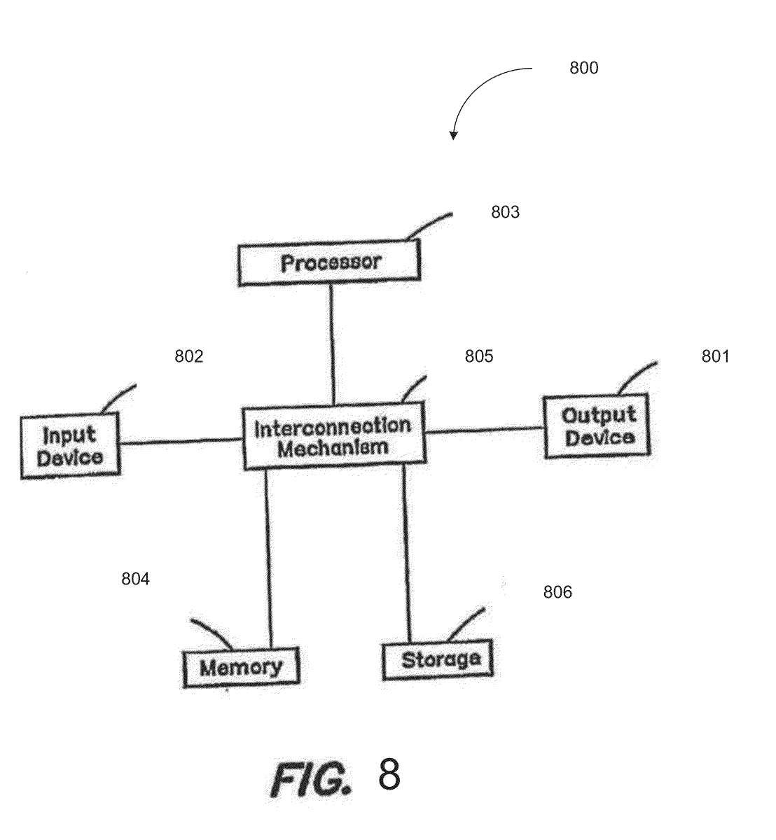

The service 100 may be implemented as a cloud-based computing platform, such as the EC2 platform, available from Amazon.com, Seattle, Wash. However, it should be appreciated that other platforms, models, and cloud-based computing services may be used to implement various aspects of the present invention. According to various examples, one or more components of the distributed network can be implemented using one or more computer systems, such as the distributed computer system 800 discussed below with regard to FIG. 8. Thus, examples of the service 100 include a variety of hardware and software components configured to perform the functions described herein and examples are not limited to a particular hardware component, software component or a particular combination thereof.

According to another aspect, the user may submit information to and receive from the service 100 via any selected interface or portal on one or more devices 108. According to some examples, the devices may include a desktop computer, a laptop computer, a tablet computer, a cellular phone, a feature phone or a smart phone. According to one embodiment, the service may be provided as a smart phone application through which a user may submit information and retrieve data. After the user enters information at block 102 via the interface on one of the devices 108, the information may be transmitted to the service at block 104. The information may be received by the service 100 and stored in a database at block 106a.

The service 100 may further include an Application Programming Interface (API), which can serve as an interface between the service and various software programs and interfaces and further facilitate their interaction. In one example, the API can interface components of the service and the applications and software programs used by the devices 108. The service can further provide one or more related services through the API, for example, the social networking platform, the messaging platform among other services.

At block 102, a user may submit user vehicle information. According to one aspect, a vehicle may include any type of machine used to transport passengers, cargo or combination thereof. In various examples, a vehicle may be a car, truck, motorcycle, recreational vehicle, boat, jet ski, snowmobile, or airplane. In one example, the vehicle information may include, but is not limited to the make, model, year, mileage and color of the user's vehicle. The user may also submit vehicle identification information such as the license plate number and the state in which the car is registered.

The user may also submit information about himself/herself, such as the user's age, gender, zip code and profession, and the user's driver history, such as the number of years the user has been licensed, the number of accidents the user has been involved in and the number of vehicle-related tickets the user has received. According to one embodiment, the service may provide for the user to provide an anonymous user identification information (e.g. user ID) or login information. The user ID or login name may include the user's license plate number or the user's license plate state plus license plate number. According to another embodiment, the user's ID or login name is a username selected by the user. According to one feature, personal information about the user remains private.

Once the user submits information to the service, the service may automatically present another interface, portal or screen for the user. According to one embodiment, after a user has submitted user vehicle identification information and received user ID is established, the user may submit queries to request information from the service. According to one feature, the service may provide a social networking platform from which the user may connect with other users based on user vehicle information.

According to one embodiment, at block 102, a user may request information from the service by inputting one or more queries via one of the devices 108. In one example, at block 102, the user requests information about car insurance prices from the service 100. The user query is transmitted to the service, and, at block 106b, the service retrieves relevant information from the database based on the query and transmits the information back to the user via one of the devices 108 at block 110. According to one feature and as further described below, the relevant information may include statistical information such as car insurance price averages, medians, high and lows for users with similar vehicle information profiles.

According to one embodiment, the user may select certain characteristics of a pool of users from which the statistical information may be calculated. For example, the user may request that the vehicle information of the users in the user pool indicate that the vehicles are all registered in the same state as the user. In another example, the user may request that the vehicle information of the users in the user pool indicate that the vehicles are all registered in the same city as the user. In yet another example, the user may request that the vehicle information of the users in the user pool indicate that the vehicles are all registered in an area within a selected distance from the user.

According to another embodiment, at block 102, a user may search for other users having similar vehicle information by inputting a query to the service 100. The user may connect with other users having similar vehicle information, and may establish a personal social network with other users based upon other users' vehicle information. The user may search for comments or questions posted by users having similar vehicle information, or the user may post a comment or question for others to answer. According to one example, the user may search for comments associated with questions posted by users with user-selected vehicle information, or by users with vehicles registered in a selected area or with a certain driving history.

According to one embodiment, establishing the user's personal social network may include accepting connection requests from other users. In one example, once the connection request is accepted, the accepting user may follow the requesting user's activities and vice versa (e.g. by using interface provided by the service 100). In addition, the users that are part of each other's personal social network may have wider access to the requesting user's profile, including content previously posted by the user part of the personal social network. Other features of the social network may include an online marketplace that may be provided to the user via service 100. In one aspect, the online marketplace allows users to include requests to buy or offers to sell car parts and services through the online marketplace to dealers or other users who are part of the social network.

According to other example, similar to drivers adding stickers on their bumpers, users who are part of the social network can add digital “bumper stickers” onto their profile page from one or more images. For example, the images may be selected from the database part of the service 100 or the images may be self-made images. Other aspects of the social network may including the user writing and publishing automobile or legislative related articles on their profile and have the articles featured upon review to the large audience of other users of the social network or to all the users of the service.

In addition, users may flag license plates for dangerous driving or bad parking by providing an input to the service 100. This feature may be implemented by having a database of most commonly complained plates stored on the service 100, and a user may input a search for a license plate or input a new entry if the license plate is not part of the database.

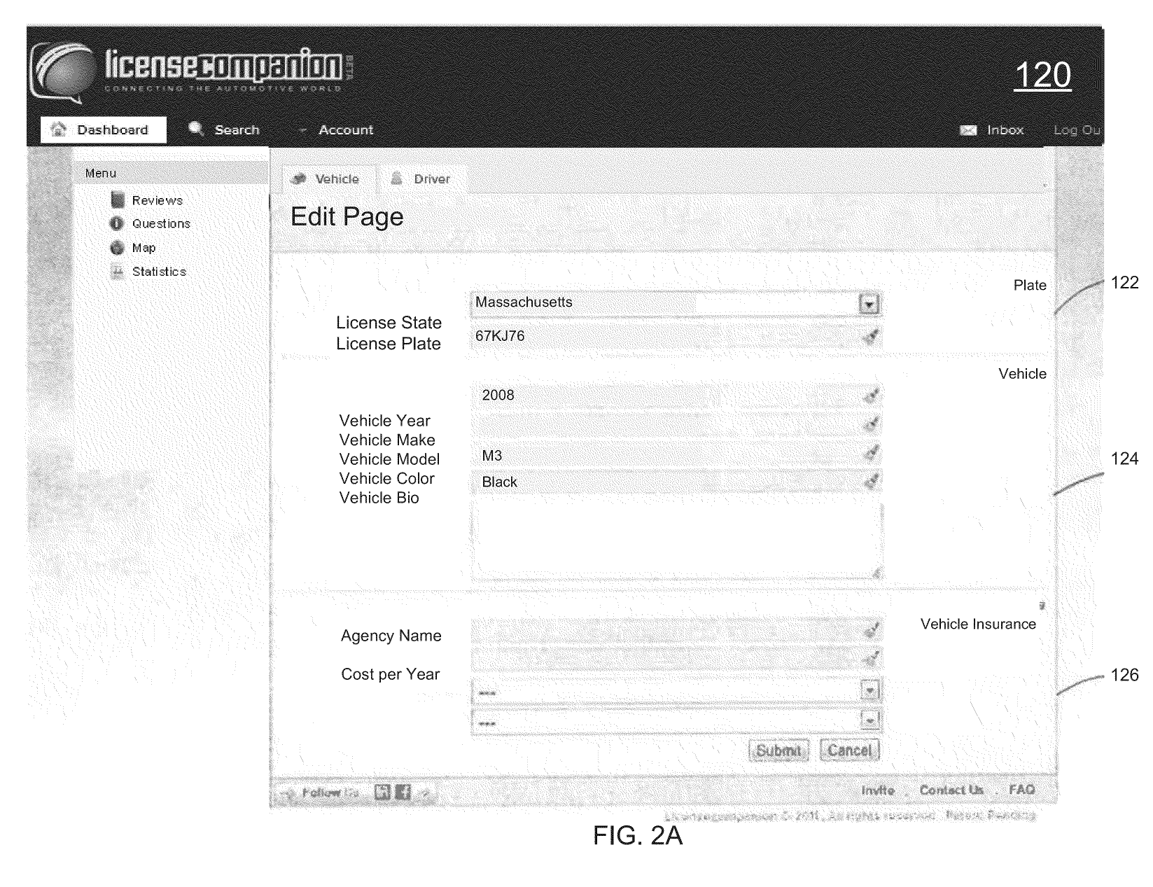

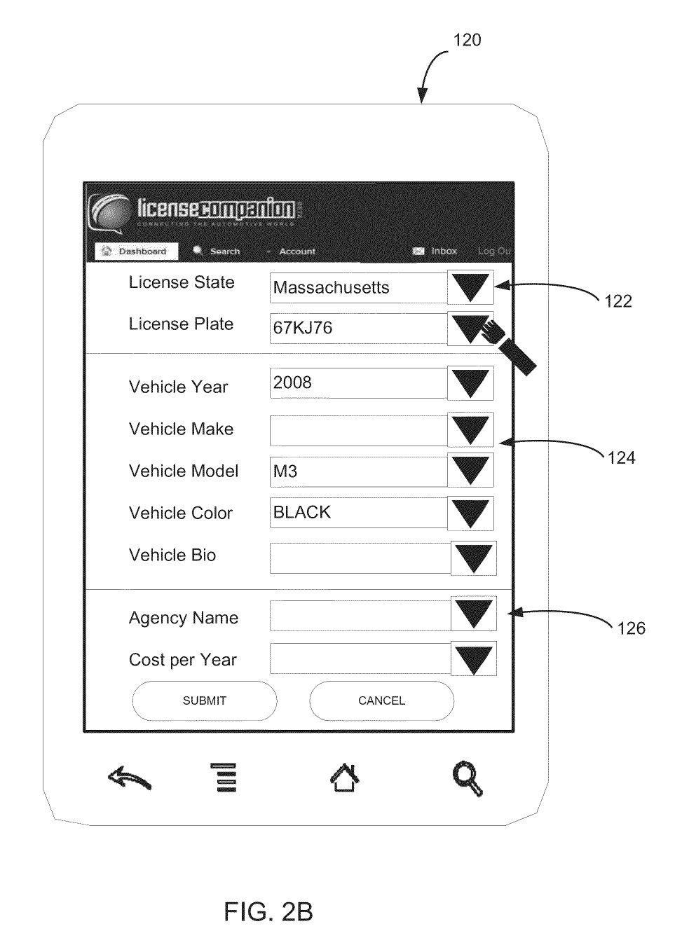

FIG. 2A shows an interface 120 including a user information input area according to one embodiment. In one example, the interface shown in FIG. 2A is a webpage for allowing a driver to create an account with the vehicle-centered service. In another example, the interface 120 shown in FIG. 2B includes a smart phone application interface. For instance, as shown in FIGS. 2A-2B, the interface 120 (either a webpage, smart phone interface, or other interface type) may include a vehicle identification input area 122, where information pertaining to vehicle registration may be entered. In the input area 122 the user may select the state in which the user's vehicle is registered and enter the vehicle's license plate. According to one embodiment, the vehicle identification information may be used as the user ID for the service. According to one embodiment, if a user has two vehicles, the user may be assigned two user IDs—one ID assigned to each vehicle. According to another embodiment, the user may select a user ID, and a user may include more than one vehicle under the user ID.

In one example, a user may first enter the vehicle identification information, and the service 100 may pre-populate the input areas with default values, for example from pre-stored information in the service 100 or from third party sources of information. The service 100 may further allow for the user to refine the default information by making manual changes.

The interface 120 may also include a vehicle information input area 124, in which the user may input information describing the vehicle. The information input into area 124 may include the VIN number, make, model, year, exterior color, interior color, interior fabric, and mileage of the vehicle identified in the vehicle identification input area 122. Other information relating to the vehicle may also be collected and input to the interface 120. For example, a user may enter the vehicle body style (e.g., couple, sedan, convertible), the number of seats in the vehicle, highway miles per gallon (mpg), city mpg, the Manufacturer's Suggested Retail Price (MSRP), the transmission type (e.g., standard, automatic), the drive type, the engine type (e.g., gasoline, diesel, hybrid), interior materials (e.g., cloth, leather), other features (e.g., air conditioning, navigation system, cruise control, entertainment system, heated seats), and safety features (e.g., airbags, stability control, security system). The vehicle information input area 124 may also include space for a user to enter additional information.

In some examples, the vehicle information may be accessed from a database associated with the service 100 and automatically filled into the vehicle information input area. In at least one example, the database may include vehicle information pertaining to various makes and models or vehicle. According to one example, a user may input make and model of the vehicle and the service may access standard information for that make and model from the database. In this example, the user can edit or delete the standard information with custom inputs.

The interface 120 may also include a driver information input area, in which the user may input information pertaining to the driver. For example, the driver related information may include the driver's age and gender. The driver information input area 126 may also include a space for the driver to indicate his or her profession and zip code. The interface 120 may also include an insurance input area 126 may include a space for a user to indicate the insurance agency name and the cost of insurance per year. In some examples, the interface may further an input area for the user to indicate the number of years the user has been licensed to drive, the number of speeding tickets the user has received, the number of accidents in which a user has been involved, or the number of points a user has for car insurance purposes.

In one example, the service 100 provides an interactive map to be displayed to a user. The user may provide an input to the map to specify his or her commute path. The information received from the user may be determined by the service 100 to correspond to geographic representation on the map. The service may also provide for the user to search along the commute path for other vehicles or users. According to one feature, the service may compare the commute path to the compute path of other users to identify others with similar commute paths. Once other users with similar commute paths are identified they may be displayed to the searching user. The service 100 may provide for the users with similar commute paths to post questions and answers, discuss traffic and alternative routes, or connect for carpooling, via the messaging platform or the online chat platform.

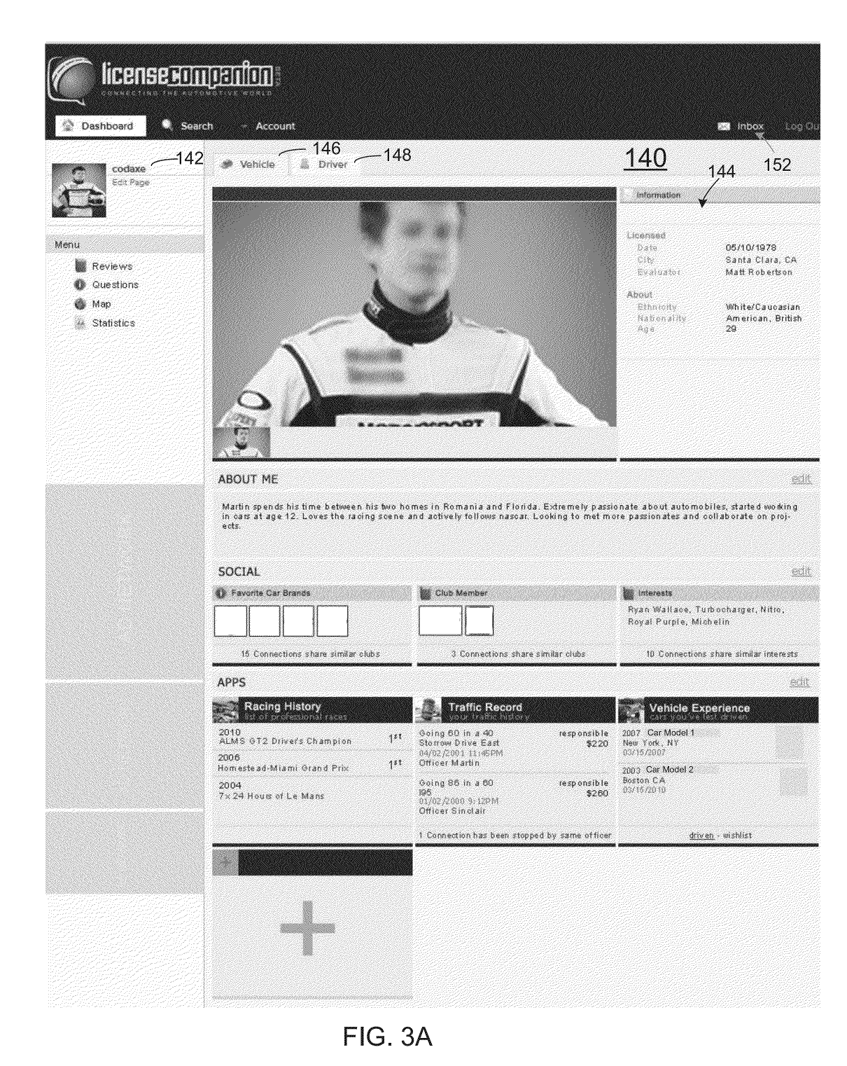

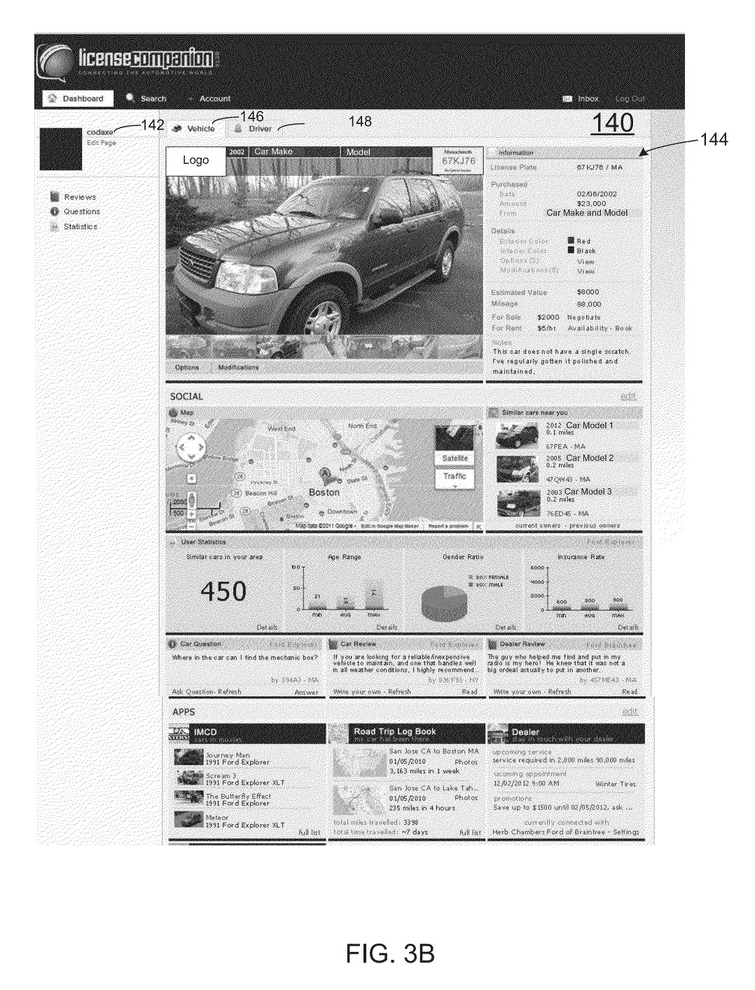

FIGS. 3A and 3B are example illustrations of a user profile screen 140, according to an embodiment of the invention. The user's username 142 may be displayed at the top of the screen 140, which may include two distinct areas that can be selected and include area identifying information for the vehicle 146 and identifying information for the driver 148. In one example implementation, the two areas can be selected by respective tabs, for instance: a vehicle tab and a driver tab.

The information associated with the driver area 148 is shown in FIG. 3A. The service 100 may provide for the user to input the information pertaining to the user in the user profile screen 140 shown in driver area 148. For example, the service may provide for the user to upload a photograph of the user which may be displayed on the driver area 148. In addition, the service may allow for the user to input information describing the user, which may be displayed in the “about me” section of the driver area 148. The driver information may include, ethnicity and nationality information, age, and the date and location of the user's driving license, as shown in FIG. 3A. Other information may be included. In addition, the service 100 may allow for the user to input information pertaining to user's interests, favorites, experience, driving record, racing history and vehicle insurance.

According to one example, the service 100 may include a messaging platform, through which the user can receive incoming messages from other users, respond to messages, or create new mail messages. The messages can be received by the service 100 from one or more users via the devices 108 and transmitted to one or more users from the service 100 to one or more devices 108. In one example, the messaging service may be accessed by accessing an inbox 152, included in the screen 140, where the messages can be viewed by the user. In another example, the service 100 may include a chat service that provides for users to send and receive message from other users via the service 100. The chat service may provide for users to receive and send messages to other users logged (e.g. “online”) into the service at the same time.

In the vehicle area 146 shown in FIG. 3B, vehicle identification 144 may be displayed. Other vehicle information, such as the make, model, year, mileage, exterior color, interior color and interior fabric may also be displayed. The vehicle identification 144 may include license plate identification, including the state and the license plate number. According to one embodiment, the background image of the license plate of each state is saved in the system. In one example the image is saved in a vector format image. The background image may be used to create an approximation of how the license plate looks for display on the home screen 140. In addition, the user's vehicle make may also be displayed at the top of the screen.

According to other embodiments, the service 100 may search for other vehicles similar to the vehicle associated with the user. The service 100 may display the similar vehicles to the user in the vehicle area 146, and may further display the location of the similar vehicles on a map. According to one example, the vehicle area 148 may include additional applications which the user may manage in the vehicle area 148. In one example, the service 100 may provide a road trip log book app for the user's vehicle. The road trip log book app may allow the user to enter information pertaining to trips taken in the vehicle. The user may enter starting point of the trip and end point of the trip and the service may calculate information, such as mileage and route associated with the trip. The trip information may be displayed in the vehicle area 148. In other example, other applications may be provided, such as the movie app, displaying to the user a list of movies associated with the vehicle.

According to one aspect, the service 100 includes a vehicle rental feature. Using the vehicle rental feature, users may put their vehicles up for rent. Users may elect to rent their vehicles to other users for a selected number of hours or days. Users interested in renting a vehicle may view rental vehicle profiles including vehicle identification, such as the license plate, and vehicle information including make, model and year. Users may also include a photograph of the vehicle. According to one feature, the renter pays the rental fee to the vehicle owner through the service. According to another feature, the service uses information about other vehicle rentals to provide a user with statistics on the potential rental income of the user's vehicle.

According to another aspect, the service includes a vehicle auctioning feature. Using the vehicle auctioning feature, users may auction off or sell a vehicle. Vehicle profiles on the auction service include vehicle identification, such as the license plate, and vehicle information including make, model and year. According to another feature, the service uses information about other vehicle sales to provide a user with statistics on the potential sale price of the user's vehicle.

According to a further aspect, users may post vehicle reviews. According to one example, a user may provide a detailed review about the vehicle the user has registered on the service. User reviews may be listed by selected vehicle characteristics such as vehicle make, model or year. User reviews may be aggregated and organized into one review, as described in greater detail in the U.S. Application titled “System and Method for Providing Statistics for User Submissions,” attorney docket number R2056-700110, filed Sep. 24, 2012, which is hereby incorporated in its entirety (hereinafter '700110 application).

According to another aspect, the service 100 allows the user the submit dealership reviews. According to one example, a user may review a dealership where the user purchased the vehicle the user has registered on the service, or a user may review a dealership where the user had the vehicle serviced. The reviews may be received by the service 100 from one or more users and displayed to other users by selected vehicle characteristics such as vehicle make, model or year. User reviews may be aggregated and organized into one review, as described in greater detail in the '700110 application. The dealership reviews may be provided as part of the vehicle area 146.

According to another aspect, dealerships or vehicle manufacturers may power news, recall notices, or promotions to the service. In one embodiment, users may sign up to receive news, recall notices or promotions from selected dealerships and/or vehicle manufacturers. In another embodiment, the service may post dealership or vehicle manufacturer information related to the user's vehicle profile along a sidebar or other place on a webpage accessed by the user.

It is appreciated that some drivers may want to be searchable and available for communication on the site without necessarily giving away their real identity. The service may provide for the user to set the privacy settings and preferences and display information based on those preferences. For example, it may be common for those users who are passionate about their high-end or tweaked hybrid vehicles to want to network purely on the basis of interest versus vanity. According to one example, the identifying information in the driver area 148 may be kept private, while other driver information and the information in the vehicle area 146 may be provided to other users of the service. According to another example, the information in the driver area 148 is kept private, while other driver information and the information in the vehicle area 146 may be provided to other users by the service.

According to one aspect, a user may submit a request for information from the service 100. In one example, a user may request statistics about users having particular makes and models of vehicles. In another example, a user may compare insurance premiums of users with selected vehicles and driver profiles. For example, a user may compare insurance premiums of users who have similar vehicle information and who have cars registered in a similar location. Notably, the insurance premium information is submitted by users and shared with other users rather than being determined by an insurance company.

It is appreciated that user submitted insurance information provides for infrastructure reliability. According to various aspects, to query insurance premium information on demand from insurance companies may necessitate reliable infrastructure between the service 100 and the systems associated with insurance companies. Setting up such infrastructure, which may need to handle large amount of requests without delay, may be impractical for every insurance provider. Instead, the social comparison of user submitted insurance premiums accessible via the service 100 can provide a company agnostic source of insurance premiums without the need for such infrastructure. Receiving sharable insurance premium information and presenting this information to the users of the service 100 can help the user discover cheaper insurance for the user and give the user leverage when negotiating with insurance companies.

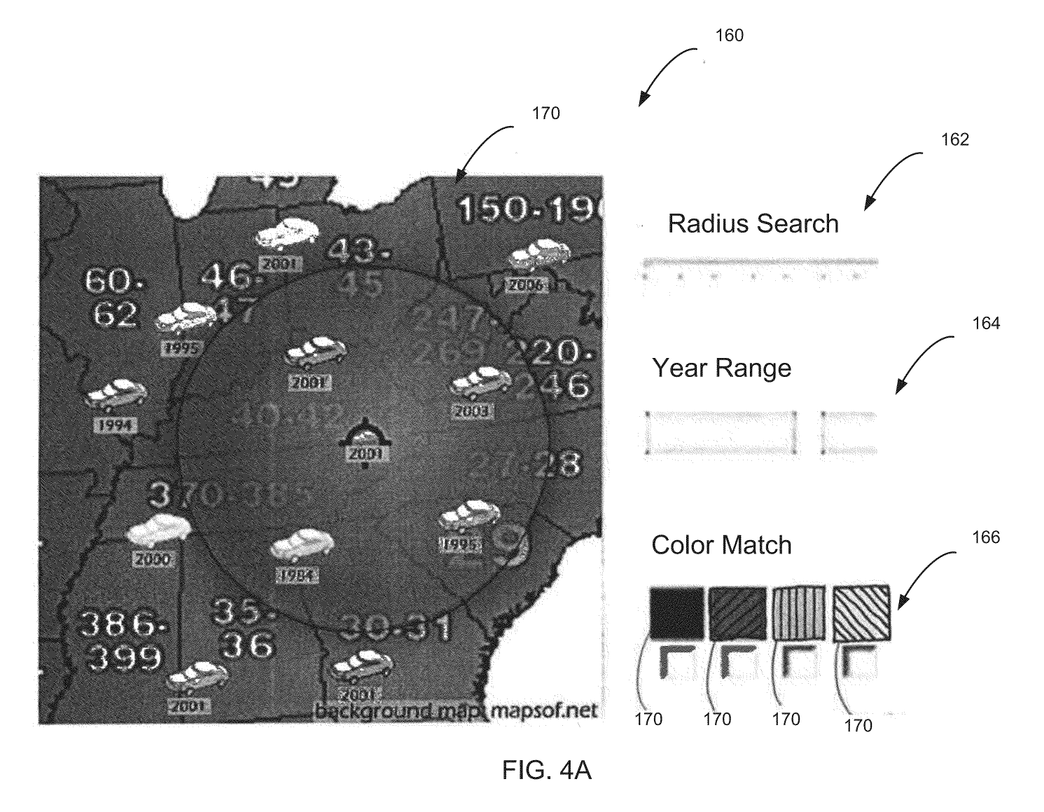

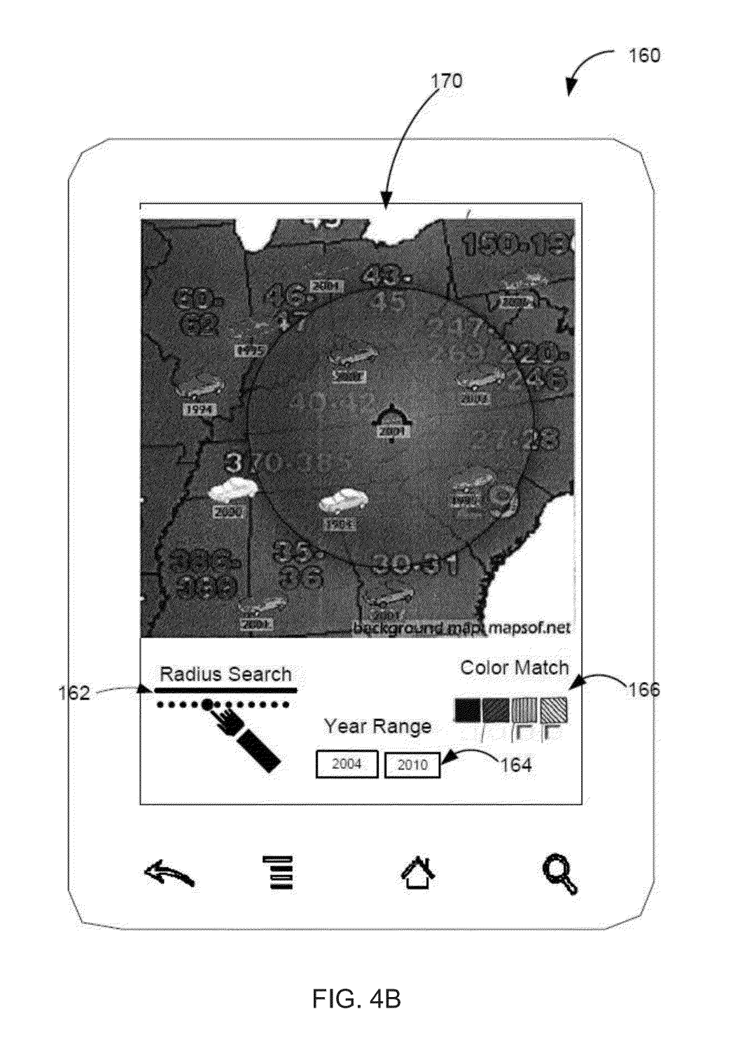

FIG. 4A shows an example illustration of a user interface 160 including parameters which may be set by a user for filtering information retrieved in response to a user query, according to one embodiment of the invention. As shown in FIG. 4A, the interface 160 may be provided as a webpage. FIG. 4B shows another example illustration of the user interface 160 including parameters set by the user provided as an application on a smart phone. In one example, the user interface 160 (either a web page interface, smart phone interface, or other interface type) may be provided on one of the devices 108 and may display the information retrieved from the service 100. In one example, the information retrieved from the service 100 may be stored locally on one of the devices 108. In this example, in response to the user adjusting or filtering the retrieved information, the information matching the adjusted or filtered parameters is searched for locally and displayed by the service 100. In another example, the information retrieved from the service 100 may be displayed, in real-time, as it is retrieved. In one example, in response to the user adjusting the retrieved information, an updated search query is sent to the service 100 including updated parameters and updated information is received from the service.

In one implementation, the user interface 160 includes an interface bar 162 that allows the user to adjust the radius of the search. The search area corresponding to the selected search radius is shown in the map 170. The information pertaining to the search area is transmitted to the service, which performs a search in the database, retrieves and transmits vehicle results matching the parameters included in the search area to the interface 160. In one embodiment, the map 170 also shows the icons for each user vehicle within the selected area. In one example, icons for each user vehicle are only shown when there are fewer than about twenty user vehicles within the selected search area.

In another implementation, the user interface 160 also includes an adjustable selection bar 164, which a user may use to adjust the range of vehicle years to include in the search. The information pertaining to the vehicle year is transmitted to the service, which performs a search in the database, retrieves and transmits vehicle results matching the vehicle year parameters to the interface 160. For example, a user may choose to include vehicles with model years between 2004 and 2006, or a user may choose to include vehicles with model years between 2000 and 2008. According to one feature, the vehicle icons on the map 170 include the model year of the vehicle.

In another example, the user interface 160 may include a color-match interface 166 that allows a user to select the color of the vehicles to include in the search. The color match interface 166 includes first 168a, second 168b, third 168c and fourth 168d colors. The information pertaining to the vehicle color is transmitted to the service 100, which performs a search in the database, retrieves and transmits vehicle results matching the color parameters to the interface 160. In one example, the first color 168a is black, the second color 168b is red, the third color 168c is orange, and the fourth color 168d is yellow. In another example, the first color 168a is black, the second color 168b is red, the third color 168c is blue, and the fourth color 168d is white. In other examples, the color match interface 166 includes five, six, seven, eight, nine, ten, or more than ten colors a user may select. In one embodiment, the color match interface includes a button which a user may select to include all colors in the search. According to one feature, the vehicle icons on the map 170 include are colored the same color as the vehicle the icon represents.

According to various embodiments, the user interface 160 may include other parameters which may be set by a user. For example, the user interface 160 may include one or more of the driver's age, the driver's gender, the driver's profession, and an option to include other similar vehicles. A driver's age interface may allow a user to select a range of ages. A driver's gender interface may allow a user to select either gender or include both genders. An interface allowing users to include other vehicles may automatically display a selected number of similar vehicles, and the interface may have a separate button for each vehicle (make and model) the user would like to include. According to one feature, the user may adjust the number of other vehicles displayed. Similar to the description above, the information pertaining to these parameters pertaining to the user may be transmitted to the service, which performs a search in the database and retrieves and transmits results including vehicles matching the driver parameters to the interface 160.

In other examples, a user may search for other vehicle information, such as the vehicle body style (e.g., couple, sedan, convertible), the number of seats in the vehicle, highway miles per gallon (mpg), city mpg, the Manufacturer's Suggested Retail Price (MSRP), the transmission type (e.g., standard, automatic), the drive type, the engine type (e.g., gasoline, diesel, hybrid), interior materials (e.g., cloth, leather). A user may search for vehicles with other additional features such as air conditioning, a navigation system, cruise control, an entertainment system, or heated seats. A user may also search for selected safety features such as airbags, stability control and a security system. Similar to the description above, the information pertaining to these parameters pertaining to the vehicle may be transmitted to the service, which performs a search in the database, retrieves and transmits vehicle results including vehicles matching the vehicle parameters to the interface 160.

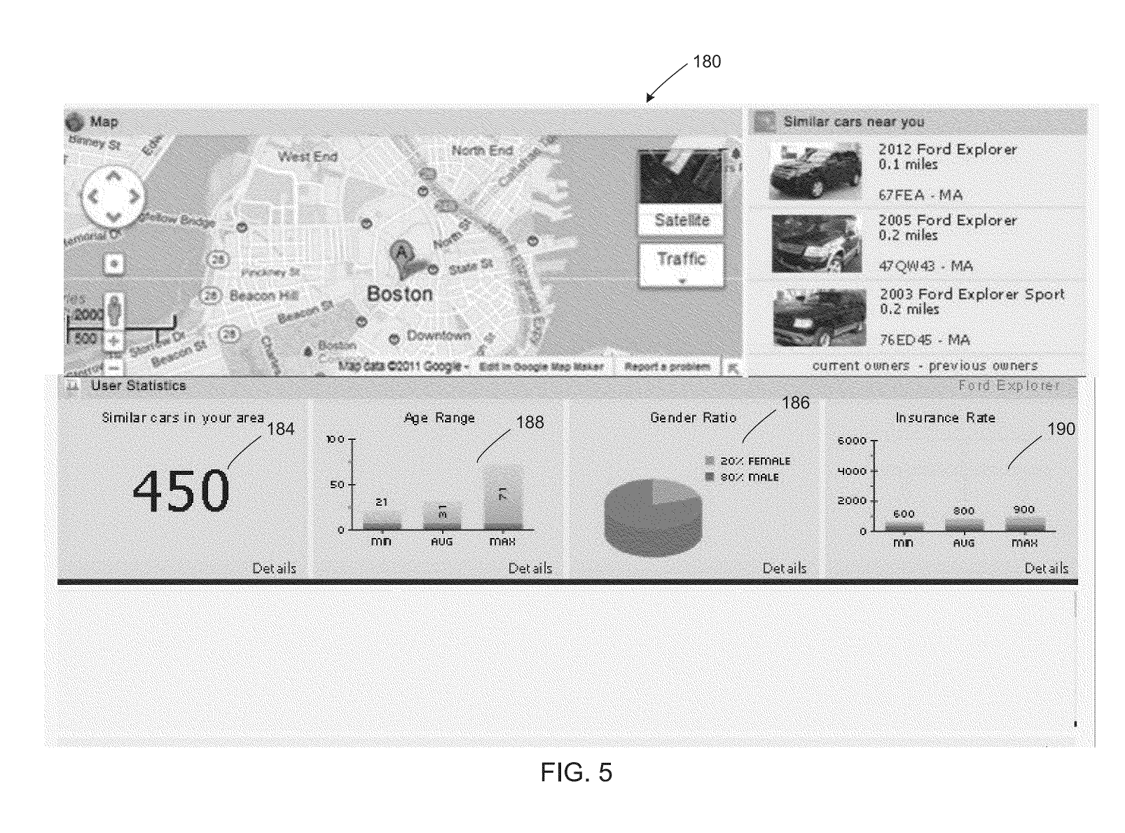

In response to a user query, the service 100 can retrieve and compile vehicle and driver statistics from a database. FIG. 5 shows an example interface 180 including parameters which may be displayed by the system in response to a user query, according to one embodiment of the invention. In one example, the interface 180 may be displayed as part of the user profile, such as the user profile 140. In various examples, the interface 180 includes a map 182 showing the region from which the statistics are calculated. According to one feature, the interface 180 includes statistics for the selected region and statistics for other users whose vehicles are not registered in the selected region.

In the illustrated example, the interface 180 includes a count 184, indicating the number of users included in the statistics, a driver gender chart 186 showing the percentage of users who are male versus female, an age range bar chart 188 showing number of drivers in selected age ranges, and an insurance premium chart 190 showing the insurance premiums charged to drivers in different age groups.

As shown on the interface 180, the count 184 shows the number of user vehicles in the selected zip code on the left and the number of user vehicles outside the selected zip code on the right. The driver gender chart 186 include a chart showing the percentage of user vehicles owned by men versus women in the selected zip code on the left and chart showing the percentage of user vehicles owned by men versus women outside the selected zip code on the right. The age range chart 188 shows a bar chart displaying the minimum age, the average age, and the maximum age of users owning the selected vehicle within the selected zip code on the left, and a bar chart displaying the minimum age, the average age, and the maximum age of users owning the selected vehicle outside the selected zip code on the right. The insurance premium chart 190 shows a bar chart displaying the minimum, average and maximum insurance premiums reported by users for the selected vehicle in the selected zip code on the left, and a bar chart displaying the minimum, average and maximum insurance premiums reported by users for the selected vehicle outside the selected zip code on the right.

In another example, the interface 180 includes a statistic showing the minimum, average and maximum number of speeding tickets received by drivers of the selected vehicle. In a further example, the interface 180 includes a statistic showing the minimum, average and maximum number of accidents the drivers of selected vehicles have been involved in. In other examples, the speeding tickets or accidents may be shown in a graph form, and the data may be compared with the insurance premiums to indicate whether there is a correlation. In another example, the interface 180 includes a list showing the most common professions of drivers of the specified type of car. According to one feature, this may be of interest to users who own the same type of car, or who are viewing the statistics to help determine what type of car to purchase. Additionally, although the statistics on the interface 180 are shown in bar charts and pie charts, in various embodiments, the statistics may be displayed using any type of graph or graphics.

According to one embodiment, the service 100 may receive a user selection requesting a specific statistic and displays vehicle information of the users who are included in the statistic. According to one feature, the service allows a user to pinpoint a specific other user through the statistics and the system allows the user to initiate contact with the selected specific user. The selected specific user remains anonymous, with only a user name or a license plate number visible to other users along with selected vehicle information. In one example, the service allows the user who initiated the search query to contact a selected specific user to ask which vehicle insurance company the selected specific user uses.

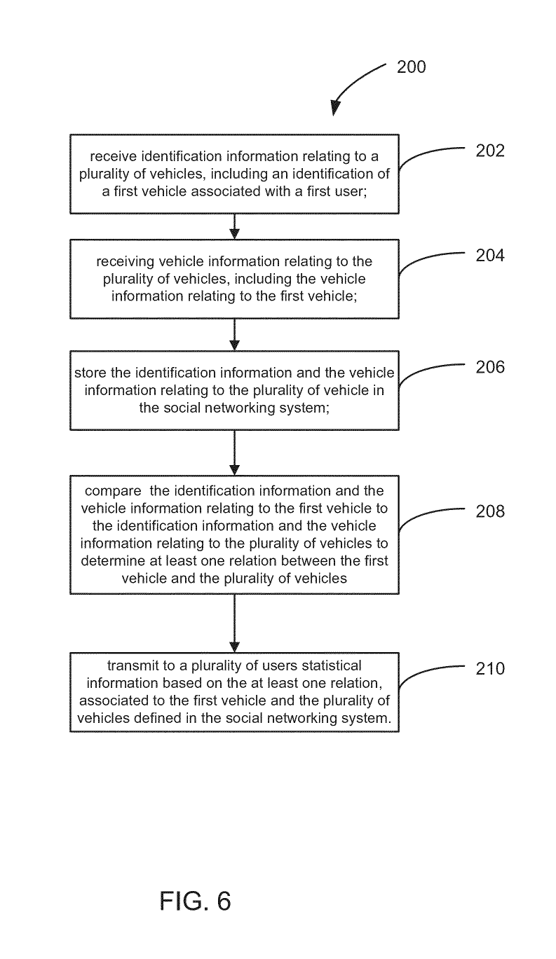

FIG. 6 shows a flow chart of a method 200 for sharing vehicle information according to an embodiment of the invention. At step 202, the service receives identification information relating to one or more vehicles, including an identification of a first vehicle associated with a first user. At step 204, the service receives vehicle information relating to the one or more vehicles, including the vehicle information relating to the first vehicle. At step 206, the service stores the identification information and the vehicle information relating to the one or more of vehicles to define the social networking system. At step 208, the service compares the identification information and the vehicle information relating to the first vehicle to the identification information and the vehicle information relating to the other vehicles in the social network system. The service determines at least one relation between the first vehicle and the plurality of vehicles, based on the vehicle information. For example, the service 100 may determine other vehicles having similar vehicle information and user information, for example, make and model of the vehicle, age and gender of the drivers, as well as other information. At step 210, the service 100 transmits to one or more users statistical information based on the at least one relation, associated to the first vehicle and the plurality of vehicles defined in the social networking system.

According to one embodiment, the service allows a first user to obtain statistical information about other users with similar vehicles. To provide the statistical information, a subset of service users is selected based on one or more characteristic of each user's vehicle information. User vehicle statistics are calculated based on the vehicle information of the subset of users and provided to a first user. According to one feature, each user in the subset of users is identified based on one or more characteristics of each user's vehicle identification. According to another feature, the first user may communicate with other users in the subset of users.

In one embodiment, the subset of users is selected based on a first user's query. For example, subset of users may be selected such that the characteristics of the vehicle information of the subset of users corresponds to vehicle characteristics entered the first user's search query. In another embodiment, the subset of the users is selected based on a first user's vehicle information. For example, users with vehicle information that is similar to the first user's vehicle information may be selected.

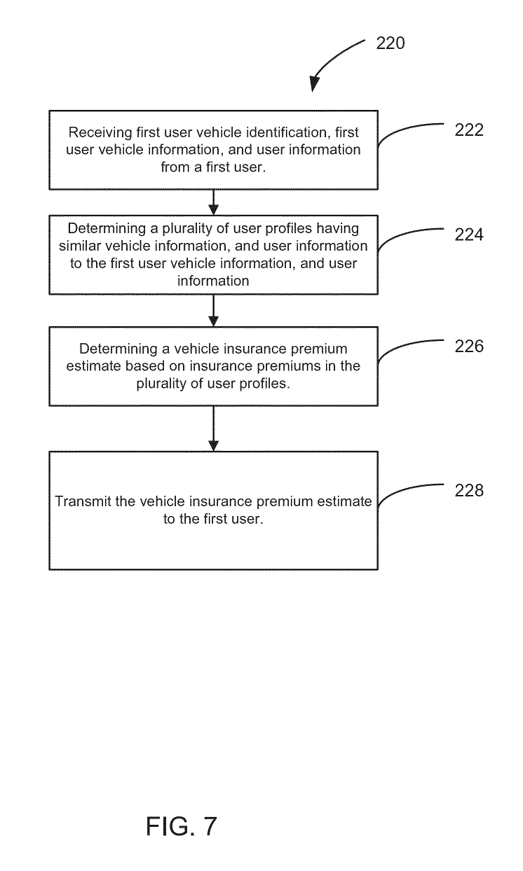

FIG. 7 shows a flow chart of a method 220 for providing a vehicle insurance premium estimate according to an embodiment of the invention. At step 222, first user vehicle identification, first user vehicle information, the first user's driver history, and the first user's vehicle registration location are received from a first user. At step 224, a plurality of user profiles having similar vehicle information, driver history and registration location may be determined based on the first user vehicle information, the first user's driver history, and the first user's vehicle registration location. At step 226, a vehicle insurance premium estimate is calculated based on insurance premiums in the plurality of user profiles. At step 228, the vehicle insurance premium estimate is provided to the first user. According to one feature, the first user vehicle information includes at least one of make, model, year, mileage, exterior color, interior color, and interior fabric of the first user's vehicle.

### Example Computer Implementations

Processes described above are merely illustrative embodiments of systems that may be used to create and manage a vehicle-centered service according to various aspects of the present invention. Such illustrative embodiments are not intended to limit the scope of the present invention, as any of numerous other implementations for performing various aspects of the invention. None of the claims set forth below are intended to be limited to any particular implementation, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component. It should be appreciated that the invention is not limited to executing on any particular system or group of systems. Also, it should be appreciated that the invention is not limited to any particular distributed architecture, network, or communication protocol.

Further, on each of the one or more computer systems that include one or more components of service 100, each of the components may reside in one or more locations on the system. For example, different portions of the components of service 100 may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

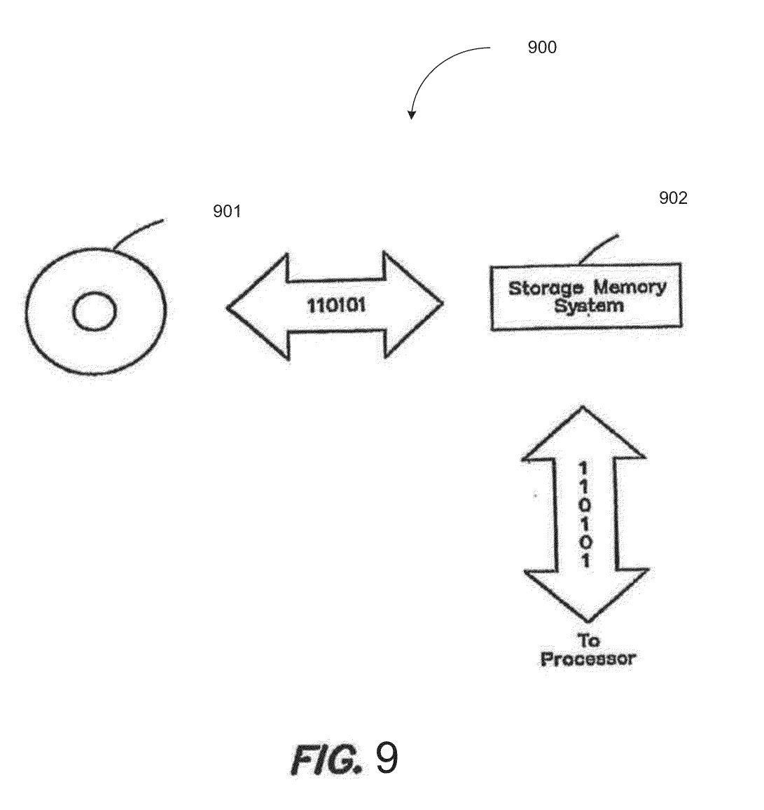

Any number of systems of the service described herein may be implemented on a computer system described below in relation to FIGS. 8 and 9. In particular, FIG. 8 shows an example computer system 800 used to implement various aspects. FIG. 9 shows an example storage system that may be used.

System 800 is merely an illustrative embodiment of a computer system suitable for implementing various aspects of the invention. Such illustrative embodiments are not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate integration of the vehicle information social network services with the other systems and services according to various embodiments of the invention. Further, the software design system may be located on a single computer or may be distributed among a plurality of computers attached by a communications network.

For example, various aspects of the invention may be implemented as specialized software executing in a general-purpose computer system 800 such as that shown in FIG. 8. The computer system 800 may include a processor 803 connected to one or more memory devices 804, such as a disk drive, memory, or other device for storing data. Memory 804 is typically used for storing programs and data during operation of the computer system 800. Components of computer system 800 may be coupled by an interconnection mechanism 805, which may include one or more busses (e.g., between components that are integrated within a same machine) and/or a network (e.g., between components that reside on separate discrete machines). The interconnection mechanism 805 enables communications (e.g., data, instructions) to be exchanged between system components of system 800. Computer system 800 also includes one or more input devices 802, for example, a keyboard, mouse, trackball, microphone, touch screen, and one or more output devices 801, for example, a printing device, display screen, and/or speaker. Further, the computer system 800 may include a Global Positioning System (GPS) configured to determine the location of the computer system 800. In one example, the information may be received from the GPS and transmitted to the GPS. In addition, computer system 800 may include one or more interfaces (not shown) that connect computer system 800 to a communication network (in addition or as an alternative to the interconnection mechanism 805).

The storage system 806, shown in greater detail in FIG. 9, typically includes a computer readable and writeable nonvolatile recording medium 901 in which signals are stored that define a program to be executed by the processor or information stored on or in the medium 901 to be processed by the program. The medium may, for example, be a disk or flash memory. Typically, in operation, the processor causes data to be read from the nonvolatile recording medium 901 into another memory 902 that allows for faster access to the information by the processor than does the medium 901. This memory 902 is typically a volatile, random access memory such as a dynamic random access memory (DRAM) or static memory (SRAM). It may be located in storage system 806, as shown, or in memory system 804, not shown. The processor 803 generally manipulates the data within the integrated circuit memory 804, 902 and then copies the data to the medium 901 after processing is completed. A variety of mechanisms are known for managing data movement between the medium 901 and the integrated circuit memory element 804, 902, and the invention is not limited thereto. The invention is not limited to a particular memory system 804 or storage system 806.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 800 is shown by way of example as one type of computer system upon which various aspects of the invention may be practiced, it should be appreciated that aspects of the invention are not limited to being implemented on the computer system as shown in FIG. 8. Various aspects of the invention may be practiced on one or more computers having a different architecture or components that are shown in FIG. 8.

Computer system 800 may be a general-purpose computer system that is programmable using a high-level computer programming language. Computer system 800 may be also implemented using specially programmed, special purpose hardware. In computer system 800, processor 803 is typically a commercially available processor such as the well-known Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista or Windows 7 operating systems available from the Microsoft Corporation, MAC OS Snow Leopard, MAC OS Snow Lion operating systems available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, CSS, XML or other format that, when viewed in a window of a browser program, render aspects of a graphical-user interface (GUI) or perform other functions). Various aspects of the invention may be implemented using various Internet technologies such as, for example, the well-known Common Gateway Interface (CGI) script, PHP Hyper-text Preprocessor (PHP), Active Server Pages (ASP), HyperText Markup Language (HTML), Extensible Markup Language (XML), Java, JavaScript, Asynchronous JavaScript and XML (AJAX), Flash, and other programming methods.

In one example, the various embodiments may be implemented using a Software Development Kit (SDK) such as the iOS Software Development Kit, available from Apple, Inc, Cupertino, Calif. In one example, the standard object for iOS to display HTML text (e.g. UIWebView) may be used.

Further, various aspects of the present invention may be implemented in a cloud-based computing platform, such as the well-known EC2 platform available commercially from Amazon.com, Seattle, Wash., among others. Various aspects of the invention may be implemented as programmed or non-programmed elements, or any combination thereof.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular may also embrace examples including a plurality, and any references in plural to any example, component, element or act herein may also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

1. A computer-implemented method for sharing vehicle information in a social networking system, the method comprising acts of:
receiving identification information relating to a plurality of vehicles, including an identification of a first vehicle associated with a first user;
receiving vehicle information relating to the plurality of vehicles, including the vehicle information relating to the first vehicle;
storing the identification information and the vehicle information relating to the plurality of vehicles in the social networking system;
comparing, by a processor, the identification information and the vehicle information relating to the first vehicle to the identification information and the vehicle information relating to the plurality of vehicles to determine at least one relation between the first vehicle and the plurality of vehicles, based on the vehicle information; and
transmitting to a plurality of users statistical information based on the at least one relation, associated to the first vehicle and the plurality of vehicles stored in the social networking system.

2. The computer-implemented method of claim 1, further comprising:
receiving from the plurality of users a plurality of sets of vehicle information, each set of vehicle information relating to a respective one of the plurality of vehicles;
determining a subset of the plurality of vehicles that match at least one characteristic of each set of vehicle information;
calculating user vehicle statistics based on the sets of vehicle information of the subset of vehicles; and
transmitting the user vehicle statistics to the first user.

3. The computer-implemented method of claim 2, wherein calculating is further based on sets of driver information for a subset of the plurality of users corresponding to the subset of the plurality of vehicles.

4. The computer-implemented method of claim 2, further comprising:
identifying each user of the plurality of users based on at least one characteristic of each user's set of vehicle information to determine a subset of users to define each user's social networking system; and
receiving a message from the first user to communicate with any user of the subset of users.

5. The computer-implemented method of claim 2, wherein selecting a subset of the plurality of vehicles is further based on the first set of vehicle information.

6. The computer-implemented method of claim 2, wherein selecting a subset of the plurality of vehicles is further based on the first user's search query.

7. The computer-implemented method of claim 2, wherein the user vehicle statistics include insurance premium statistics.

8. The computer-implemented method of claim 1, wherein the identification information includes any of the first vehicle license plate number and the first vehicle state of registration.

9. The computer-implemented method of claim 1, wherein the vehicle information includes any of the first vehicle make, model, year, mileage, exterior color, interior color and interior fabric.

10. The computer-implemented method of claim 1, further comprising:
receiving a plurality of reviews from a subset for the plurality of users;
transmitting the plurality of the reviews to the plurality of users;
aggregating the plurality of reviews to determine a review overview; and
transmitting the review overview to the plurality of users.

11. The computer-implemented method of claim 1, further comprising:
receiving advertisements for rent from a set of the plurality of users of the corresponding plurality vehicles; and
transmitting to the plurality of users the advertisement for rent of the corresponding plurality vehicles.

12. The computer-implemented method of claim 1, further comprising:
receiving advertisements for sale from a set of the plurality of users of the corresponding plurality vehicles; and
transmitting to the plurality of users the advertisement for sale of the corresponding plurality vehicles.

13. The computer-implemented method of claim 1, further comprising:
receiving user information from the first user;
determining, based on the vehicle information and the user information of the first user, a plurality of user profiles having corresponding vehicle information, and corresponding user information, each the plurality of user profiles having an insurance premium;
calculating an insurance premium estimate based on the insurance premiums associated with the plurality of user profiles; and
transmitting the insurance premium estimate to the first user.

14. The method of claim 13, wherein the vehicle information of the first user includes at least one of make, model, year, exterior color, interior color and interior fabric.

15. The method of claim 13, further comprising receiving driver history, and vehicle registration location of the first user.

16. The method of claim 13, further comprising receiving from a plurality of users the insurance premium.

17. A system for providing a vehicle information and social networking service, comprising:
an interface configured to receive vehicle identification and vehicle information relating to a plurality of vehicles, including identification and vehicle information of a first vehicle associated with a first user;
a storage medium configured to store the vehicle identification, and the vehicle information relating to the plurality of vehicles to define the social networking system; and
a processor configured to compare the identification information and the vehicle information relating to the first vehicle to the identification information and the vehicle information relating to the plurality of vehicles to determine at least one relation between the first vehicle and the plurality of vehicles, based on the vehicle information, wherein the interface is configured to transmit to a plurality of users statistical information based on the at least one relation, associated to the first vehicle and the plurality of vehicles defined in the social networking system.

18. The system of claim 17, wherein the processor selects a subset of the plurality of users based on a first user's vehicle information.

19. The system of claim 17, wherein the processor selects the subset of the plurality of users based on the first user's search query.

20. The system of claim 17, wherein the interface is further configured to receive user information from the first user, and wherein the processor is further configured to:
determine, based on the vehicle information and the user information of the first user, a plurality of user profiles having corresponding vehicle information, and corresponding user information, each the plurality of user profiles having an insurance premium; and
calculate an insurance premium estimate based on the insurance premiums associated with the plurality of user profiles, wherein the interface is configured to transmit the insurance premium estimate to the first user.
